(19) United States
(12) Patent Application Publication
(10) Pub. No.: US 2014/0067554 A1
(43) Pub. Date: Mar. 6, 2014

(54) PERSONALIZED INCENTIVE PROMOTIONAL PRODUCT SYSTEM

(71) Applicant: GForce Ink, LLC, Chatfield, MN (US)

(72) Inventor: GEOFF HEPPDING, Rushford, MN (US)

(73) Assignee: GForce Ink, LLC, Chatfield, MN (US)

(21) Appl. No.: 14/017,025

(22) Filed: Sep. 3, 2013

Related U.S. Application Data
(60) Provisional application No. 61/695,966, filed on Aug. 31, 2012.

(51) Int. Cl. G06Q 30/02

(52) U.S. Cl. CPC G06Q 30/0276
USPC 705/14.72

(57) ABSTRACT

Systems and methods for creating recipient-customizable promotional products are disclosed. One method includes receiving design details from a customer associated with layout of one or more graphical elements on a promotional product, and building a design of a customized promotional product using the design details. The method further includes generating a personalization symbol to be applied to each promotional product, the personalization symbol linked in a database to an offer, and making a plurality of the customized promotional products, each of the customized promotional products created according to the design details and including a personalization symbol, thereby creating personalized customized promotional products. The method also includes distributing the personalized customized promotional products to the customer.

### CROSS-REFERENCE TO RELATED APPLICATIONS

The present application claims priority to U.S. Provisional Patent Application No. 61/695,966, filed on Aug. 31, 2012, the disclosure of which is hereby incorporated by reference in its entirety.

### TECHNICAL FIELD

The present application relates generally to creation of promotional products, and in particular to a system for creating promotional products having personalized incentives associated therewith.

### BACKGROUND

Various promotional product creation systems exist, in particular in online environments, in which a user can order and customize specific products for printing and distribution. For example, a customer may elect to add specific text or graphics to a particular promotional product (e.g., a t-shirt, coffee mug, button, bumper sticker, or other product), and then order those products for delivery. In other promotional product creation systems, a customer submits a design to a promotional product maker, who then prints the design on those promotional products and returns them to the customer for distribution.

In each of these circumstances, there are drawbacks to such promotional product creation systems. For example, although some level of customization of the design is possible, that customization is limited to the overall design; separate individual promotional products, created during the same “run” of products to be printed or otherwise created, generally have identical designs. Furthermore, each of these designs is generally limited by the fact that only the customer and promotional product maker have input into the design, and therefore there is a limit to the collaboration among entities made possible by such systems. Additionally, even though often such customers distribute their promotional products at a particular event (e.g., a charity rate, barbecue, etc.), there is no integrated arrangement by which tickets for that event and promotional products can both be created.

For these and other reasons, improvements are desirable.

### SUMMARY

In accordance with the following disclosure, the above and other issues are addressed by the following:

In one aspect, a method of creating recipient-customizable promotional products is disclosed. The method includes receiving design details from a customer associated with layout of one or more graphical elements on a promotional product, and building a design of a customized promotional product using the design details. The method further includes generating a personalization symbol to be applied to each promotional product, the personalization symbol linked in a database to an offer, and making a plurality of the customized promotional products, each of the customized promotional products created according to the design details and including a personalization symbol, thereby creating personalized customized promotional products. The method also includes distributing the personalized customized promotional products to the customer.

In a second aspect, a system includes an on-demand product customizer and a customized product printing system. The on-demand product customizer includes a programmable circuit and a memory operatively connected to the programmable circuit and configured to store instructions executable thereon. The instructions, when executed on the programmable circuit, cause the on-demand product customizer to receive design details from a customer associated with layout of one or more graphical elements on a promotional product, build a design of a customized promotional product using the design details, and generate a personalization symbol to be applied to each promotional product, the personalization symbol linked in a database to content. The a customized product printing system is operatively connected to the on-demand product customizer and configured to make a plurality of the customized promotional products, each of the customized promotional products created according to the design details and including a personalization symbol, thereby creating personalized customized promotional products.

In a third aspect, a method of creating recipient-customizable promotional products is disclosed. The method includes providing design details to an on-demand product customizer, the design details associated with layout of one or more graphical elements on a promotional product, and ordering a designed customized promotional product using the design details, the design details including a personalization symbol linked in a database to one or more offers to a user. The method further includes receiving a plurality of the designed customized promotional products, each of the customized promotional products created according to the design details and including a personalization symbol, thereby creating personalized customized promotional products, and distributing the personalized customized promotional products to a plurality of individuals. The method further includes scanning the personalization symbol on one of the personalized customized promotional products of one of the plurality of individuals, transmitting information identifying the personalization symbol to a remote system, and receiving information indicative of a promotion associated with the personalization symbol to be provided to the individual.

### BRIEF DESCRIPTION OF THE DRAWINGS

FIG. 1 is a schematic view of a network in which the personalized incentive promotional product system can be implemented;

FIG. 2 is a flowchart illustrating an example embodiment of a personalized incentive promotional product system;

FIG. 3 is a schematic example of a promotional product having a personalized feature; and

FIG. 4 is a logical block diagram of a computing system in which aspects of the present application can be implemented.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for creating promotional products having personalized incentives associated therewith. By combining personalization within a vast array of merchandise with an encoded database which is reconfigurable for future and/or alternative events specific to client and/or customer, this produces an incentive-based system that overcomes the limitations stated above.

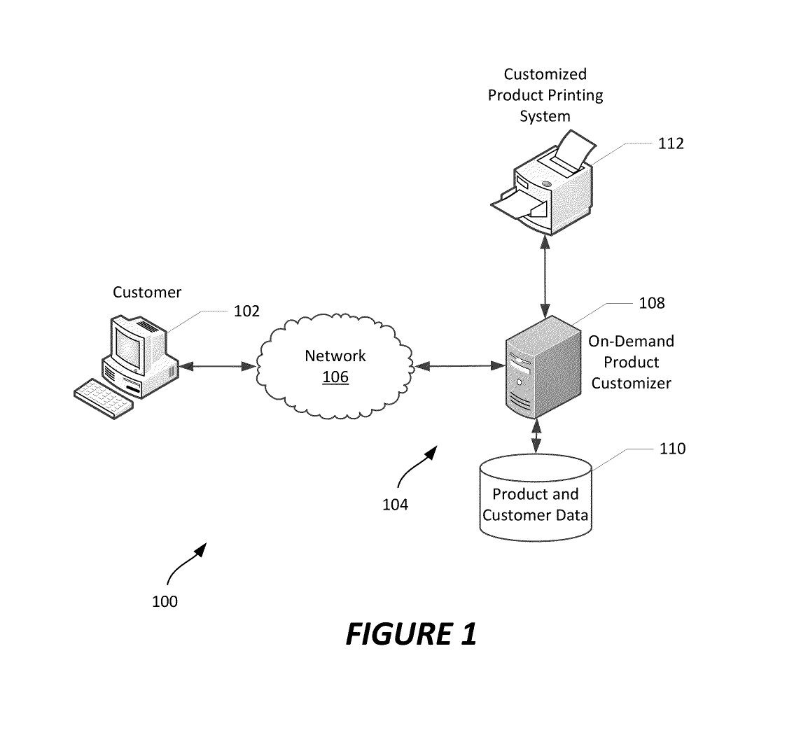

Referring now to FIG. 1, a schematic view of a network 100 in which the personalized incentive promotional product system can be implemented. The network 100 includes a customer system 102 communicatively connected to a personalized incentive promotional product creation system 104 via a network 106. The customer system 102 is operated by a customer at a location remote from the promotional product creation system 104. The customer generally corresponds to a person or entity employing the system 104 for personal, marketing, or commercial purposes. The network 106 can be any of a variety of communicative connections, such as the Internet or some other LAN, WAN or communicative connection.

The promotional product creation system 104 represents a system accessible to the customer for customization and creation of promotional products. In the embodiment shown, the promotional product creation system 104 includes a promotional product management computing system 108 communicatively connected to and managing a promotional products and personalization database 110. The promotional product management computing system 108 provides an interface by which the customer system 102 can communicate with the promotional product creation system 104 to provide custom product designs/layouts, to manage purchases of those products that are designed, as well as to manage personalizations of those products on a product-by-product basis.

The database 110 manages a variety of information, such as available promotional products, designs of those promotional products by customers, price and availability information regarding the products, and associations between one or more personalizations and a corresponding product. The personalization generally is a unique correlation between a particular promotional product and a customized incentive, message, or other feature accessible by the recipient of the promotional product by way of the promotional product management computing system 108. For example, the personalization can be a bar code or QR code printed onto a promotional product, such that when a recipient of the promotional product (i.e., a person receiving the product from the customer) captures that code, such as with a smartphone application or other analogous feature, that recipient can then be routed to a particular offer, promotion, reward, or message specifically intended for that user. Example messages or offers associated with a user can be a personal coupon for discounted goods/service, a voucher redeemable for goods/services, or other analogous feature.

In some additional embodiments, the database 110 contains other information selected and uploaded by a user, for example pictures, links, messages, or other content that the user wishes a recipient of a promotional product to view. Additional details regarding example uses of the database to access such content are described below.

In an example embodiment, the database 110 can also manage ticketing for promotional events, such that a customer can create tickets to an event at which promotional products are distributed; in some such embodiments, the promotional products associated with the event (such as a run or other activity) can be distributed prior to the event, and the personalization of the product allows the product to act as the ticket associated with that customer, and act as a recipient's ticket to an event managed by or affiliated with the customer.

In some additional embodiments, the database 110 manages inventory of items on which customizations can be applied. For example, the database 110 can be configured to manage inventory of blank, or uncustomized, shirts, tickets, glasses/mugs, key fobs, magnets, or other promotional items,

In further embodiments, the database 110 contains associations between a personalization code (e.g., a QR code) and a person to whom the personalized product is delivered, for example to provide personalized incentives or messages, or in the case of a ticketing arrangement that is specific to a user or users (i.e., is intended as a non-transferrable ticket).

The promotional product creation system 104 further includes a promotional product creation subsystem 112, illustrated as a printing subsystem, which in fact applies the customer's intended design, as well as any personalizations specific to each product, to products requested by the customer. Although in the illustration a printing process is depicted, it is recognized that a variety of types of systems could be implemented as the promotional product creation subsystem 112.

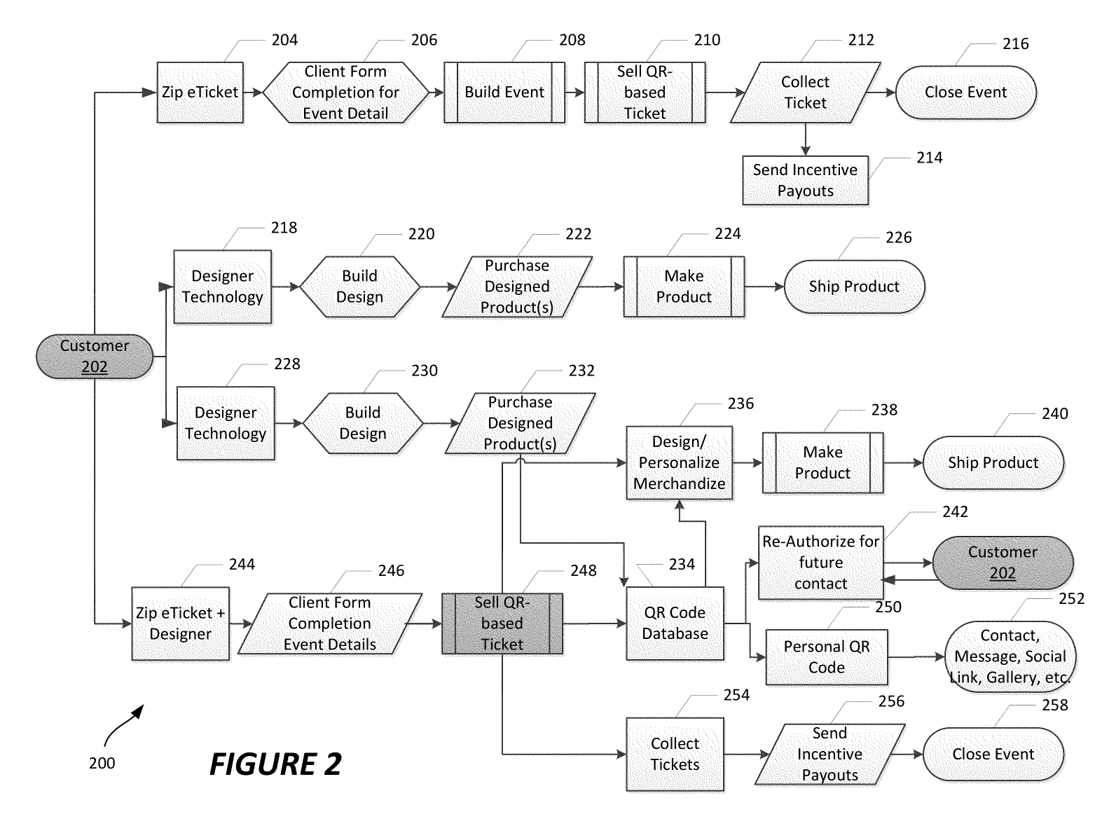

Referring now to FIG. 2, a flowchart illustrating interactions with and operations of a possible embodiment of a personalized incentive promotional product system 200, according to an example embodiment. In the example as shown, a customer interacts with the personalized incentive promotional product system 200, for example from a customer system 102. The personalized incentive promotional product system 200 can be, in some cases, implemented using promotional product management computing system 108 and associated database 110 of FIG. 1.

In the embodiment shown, the customer has a number of different ways in which they can interact with the system 200. For example, in the embodiment shown, a customer 202 can manage “tickets”, corresponding to offers or event incentives (or actual event tickets, for example for an event at which promotional products are distributed) to be distributed to customers, can design and create promotional products, and can optionally associate a QR code or other personalization with either the ticket or the promotional product, to provide a secondary incentive or message associated specifically with each individual product. As discussed above, using various QR codes, different incentives, messages, or other features can be assigned for use with each individual ticket or promotional product.

In a first example set of operations, the customer can opt to create a ticket for distribution to other individuals. In this case, the customer can visit a ticketing portion of a website made accessible by the promotional product management computing system 108 (step 204), and complete an online form (step 206). The online form receives fields describing the event, for storage in the database 110.

Upon receiving the event information, the promotional product management computing system 108 can build the event, either manually or automatically (step 208). This can optionally occur by placing the event in a “shopping cart” function, which the customers can purchase on a per-attendee or flat fee basis, thereby allowing the customer to easily set up and manage event ticketing and promotion.

A customer can, when ready, purchase QR-code-based tickets for association with the event (step 210). When the ticket is then distributed to a recipient, for example before or at an event, that ticket can be scanned at the event or by the recipient. The ticket can be verified at the event, or can be verified using the QR code and the promotional product management computing system 108. When that scanned information is passed to the promotional product management computing system 108, the association of that QR-code can be accessed from the database 110 to verify the authenticity of the code (step 212). To the extent that use of the QR code defines an incentive to be provided, such an incentive can be distributed (step 214). Once the event has occurred, it can be closed in the database 110 (step 216)

In a second example set of operations, the customer 202 can opt to create a custom product, for example for distribution at an event. The customer 202 can access a walk-through designer web interface to design the promotional product (step 218). In an example embodiment, the customer uses modular tool panel based software, customizable per web site which allows customers to dynamically build personalized products. Once approved, the design is built (step 220) and purchased (step 222), products are created (step 224), for example using the promotional product creation subsystem 112. In example embodiments, the promotional product creation subsystem can, as mentioned previously, use an internal network of storage and print technology which enables conversion of customer-designed digital files to be printed in any size quantity over a vast array of merchandise. The product can then be shipped to the customer (or picked up by the customer) for distribution at an event (or otherwise distributed) (step 226).

In a third example set of operations, the customer 202 can opt for a combined ticketing and promotional product arrangement, in which promotional products are branded with item-unique codes (e.g., QR codes, bar codes, or other printable, unique codes). This arrangement allows the promotional product itself to act as the event ticket, or to use the promotional product to encourage a user to access a product incentive after a promotional event. In this arrangement, the customer 202 designs (step 228), builds (step 230), and purchases (step 232) a designated promotional product, similar to in the previous example. However in this case, a QR code or other unique identifiable code can be generated and applied to the product design. In such circumstances, the QR code or other unique indicia is generated and registered in the database 110 (step 234), and applied to the promotional product (step 236). The promotional product can then be created (step 238), for example using a printing process or analogous process. The products can then be shipped to the ordering customer (step 240) for distribution to attendees of a promotional event. The attendees at the event can have the QR code scanned, thereby providing one or more incentives to the attendee associated with the QR code (e.g., free or discounted adminssion, prizes, raffle entries, food/drink discounts, or other incentives).

Optionally, when the QR codes are applied, the database can be constructed to allow a customer to reuse the OR code for future contact or additional information and/or promotions associated with that customer (step 242). It is noted that although in the embodiment shown the QR code can be set as reusable, in alternative embodiments, once scanned at the event, be flagged in the database 110 or otherwise removed, thereby deactivating the QR code for future uses.

In a further option, an integrated product and incentive program can be implemented such that an identifier (e.g., a QR code) on a promotional product can be used by a recipient of that product to access data placed at a particular customized website by the distributor of that promotional product. This can occur either in association with an event, or entirely disassociated from an event. If an event association is included, in the embodiment shown, the system 200 includes a combined ticketing and design process (step 244) creates tickets and associated promotional products; the customer completes a form associated with the event (step 246), and purchases a ticket set to the event that includes a QR code (step 248). Alternatively, if no event is associated, the association of a QR code during step 248 could be an association of the QR code to a promotional product, such as could be designed via the process 200, such as via steps 228-232. In such a case, the QR code would be printed on the product, rather than the ticket.

In either case, the designer of an event or promotional product could, in some cases, associate a QR code with that individual specifically, or with a particular intended recipient of the product with which the code is associated (step 250). In such cases, the recipient of the promotional product could then be used by the recipient to access content stored in the database as intended for that recipient, such as to access a message, pictures, links to websites or social media features, or other content (step 252).

In a further option, an integrated product and incentive program can be implemented, in which the QR code generator is used to brand tickets or products with the QR code, and to distribute associated products. The QR code can be unique to the ticket or product, or can be a general QR code for mass produced tickets and products.

In such a case, a combined ticketing and design process (step 244) creates tickets and associated promotional products; the customer completes a form associated with the event (step 246), and purchases a ticket set to the event that includes a QR code (step 248). Once the ticket is sold to the customer, the customer can both design merchandise (e.g. starting at step 236) or can collect tickets (step 250) and send incentive payouts to recipients of those tickets (step 252). Once incentives are distributed, the event can be closed (step 254).

Although the various steps are described in connection with FIG. 2 in a particular order, it is recognized that, in various embodiments, other orders of operations would be possible as well. Furthermore, in some cases, additional steps may be added to the process, or steps (and overall options) could be removed altogether.

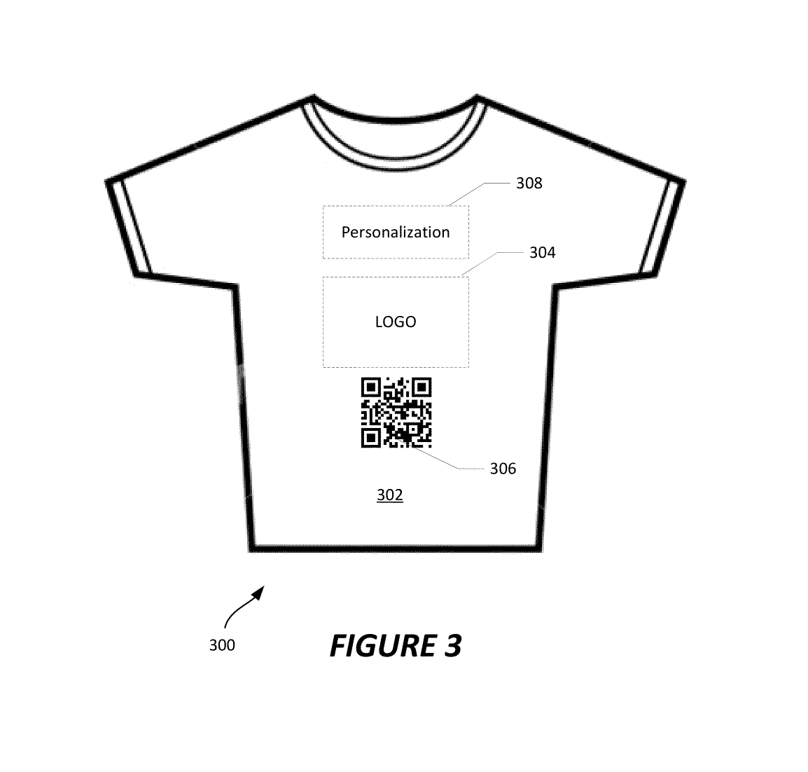

Referring now to FIG. 3, a schematic example of a personalized promotional product 300 is shown. In the embodiment shown, the personalized promotional product 300 includes a promotional product 302 having a personalized design printed thereon. Although in the embodiment shown, the promotional product 302 is a shirt, in other examples the promotional product could be a button, glass, mug, hat, pen, key fob, or other typical promotional product.

The personalized design can take a variety of forms, depending upon the features and capabilities of a promotional product creation subsystem 112. In the embodiment shown, a logo 304 is imprinted on the promotional product 302; however in alternative designs, any of a variety of text or graphical information can be placed on the promotional product. Additionally, a personalization symbol, such as a QR code 306, can be printed or otherwise placed on the promotional product as well. Additional customizations or non-QR code based personalized designs (see generally personalization 308), could be imprinted on the promotional product as well.

In some embodiments, the personalized promotional product 300 can be distributed in advance of an event, and can act as a ticket to the event. In alternative embodiments, a promotional product can be created without the personalization symbol, which can instead be printed on a separate ticket as part of the same integrated process.

Using the systems of FIGS. 1-3, a variety of example usage scenarios are apparent. Example usage scenarios are briefly discussed below; however, it is recognized that other possible usage scenarios would be possible as well.

In a first example scenario, a user of the systems 100, 200 could opt to organize an event for which tickets are required. That event could include QR codes on the ticket that incentivize sales at the event, or either before or after the event. The recipient of the ticket could scan the QR code with a mobile phone camera or other analogous device to determine the exact incentive received (which could also be printed textually on the ticket as well). Associated promotional products, customized for the event, could be printed and distributed with those tickets as well, and could in some circumstances include the QR code affiliated with the event. This would entice the recipients to bring the promotional product to the event (e.g., to wear a t-shirt or bring a glass) to receive a particular promotion. In some cases, the promotion explanation could be provided on the ticket or associated literature, with the QR code presented on the promotional product.

In a second example scenario, a user of the systems 100, 200 could opt to print QR codes associated with each intended recipient on various promotional products, where the promotional product represents the ticket to the event. In such cases, the promotional product could be a shirt, or could be a key fob, card, or other handheld/compact item.

In a third example scenario, a user of the systems 100, 200 could opt simply to create a promotional product to be sent to a particular recipient. That user can associate a QR code with that promotional product, which would allow the recipient to access online content selected and placed within the database 110 by the user.

Still other example scenarios are possible as well, depending upon the specific needs of the user, i.e., the designer or purchaser of promotional products, or recipient of such products.

Each of the various scenarios can have real-world application in a variety of contexts. For example, in a commercial graphics context, a user of the systems 100, 200 could work with a graphic designer to prepare graphical information associated with a promotional product, from the beginning of a design process through completion of the design. In such a scenario, portions of the systems are used which are constructed for customized product creation. In a second scenario, pre-created graphics, or graphics generated by a customer/user of the system could be applied to promotional products.

In a still further use of the above scenarios, the systems 100, 200 could be used as an electronic ticketing mechanism, utilizing 2D barcoding (i.e. QR codes) for validating admissions at an entry gate. In a variant of this, 2D barcoding could be used for any type of admission, and could be printed on a ticket, key fob, shirt, or other type of promotional product.

In still further possible uses of systems 100, 200, an online design tool can be presented by the system, at which a user can create imagery or custom graphics for use in printing on tickets or promotional products. The design tool is, in such embodiments, capable of receiving uploaded graphics and customized text, or could in alternative embodiments be configured only as a design tool, without the capability of importing user graphics.

In application, various end users may find utility in the systems discussed herein. For example, organizers of a local charity event could use the online ticketing arrangements to establish a guest count, in particular where capacity is limited; to establish a mechanism for collecting admission fees, and to provide either ticketed or ticketless entry (e.g., via an honor system or scan of a preexisting code system). The user can, in such circumstances, be charged a flat fee for use of the systems 100, 200, and can profit (e.g., in the event of a fundraiser) for funds raised in excess of that amount.

Other examples where the system could be used include those either with or without promotional merchandise or links to information. In a town hall meeting setting with a political candidate, the systems 100, 200 could be used to provide ticketing, and optionally a giveaway/promotional item to be given to attendees. The giveaway could be associated with a particular ticket or at random, and optionally could include a 2D barcode (QR code) that represents a link to an informational website or other materials (e.g., online videos).

Still other events, for example sponsored events, could use the system as well, such as local performance events in which personalized and customized merchandise is to be distributed. Such events could include single-instance events, or could be multiple use events (e.g., recurring events) at one or more locations, in which an entry item having a 2D barcode provides entry to the event, and optionally to additional promotions (e.g., discounts on goods at the event, such as discounted tickets to other events or for other merchandise).

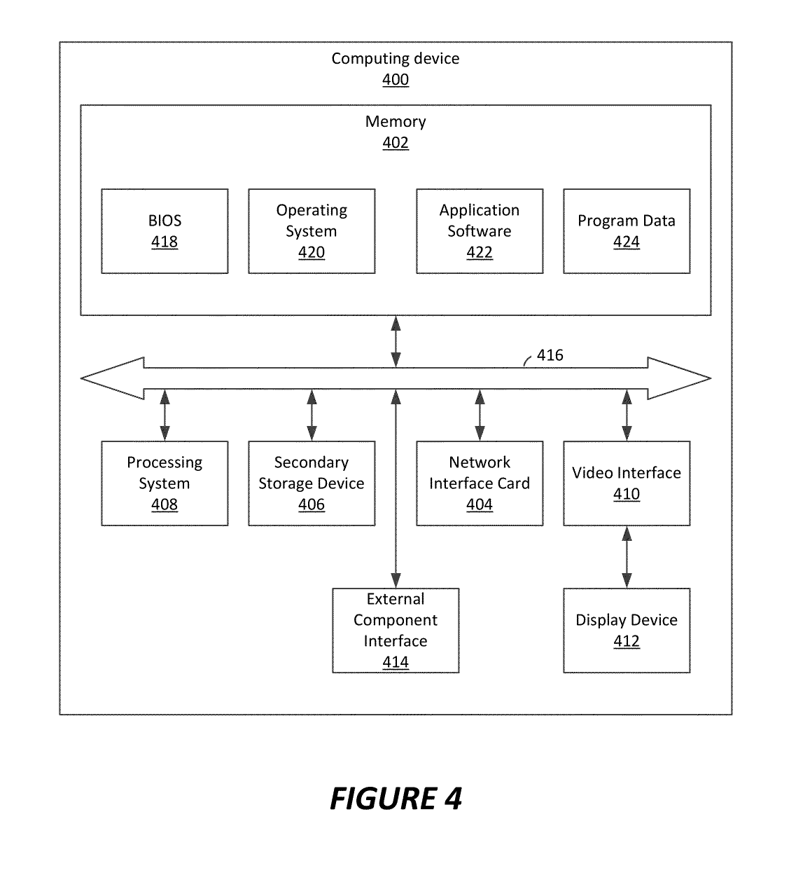

Referring now to FIG. 4, a schematic illustration of an example computing system in which aspects of the present disclosure can be implemented. The computing system 400 can represent, for example, a native computing system within which one or more of computing systems 102, 108 could be implemented.

In the example of FIG. 4, the computing device 400 includes a memory 402, a processing system 404, a secondary storage device 406, a network interface card 408, a video interface 410, a display unit 412, an external component interface 414, and a communication medium 416. The memory 402 includes one or more computer storage media capable of storing data and/or instructions. In different embodiments, the memory 402 is implemented in different ways. For example, the memory 402 can be implemented using various types of computer storage media.

The processing system 404 includes one or more processing units. A processing unit is a physical device or article of manufacture comprising one or more integrated circuits that selectively execute software instructions. In various embodiments, the processing system 404 is implemented in various ways. For example, the processing system 404 can be implemented as one or more processing cores. In another example, the processing system 404 can include one or more separate microprocessors. In yet another example embodiment, the processing system 404 can include an application-specific integrated circuit (ASIC) that provides specific functionality. In yet another example, the processing system 404 provides specific functionality by using an ASIC and by executing computer-executable instructions.

The secondary storage device 406 includes one or more computer storage media. The secondary storage device 406 stores data and software instructions not directly accessible by the processing system 404. In other words, the processing system 404 performs an I/O operation to retrieve data and/or software instructions from the secondary storage device 406. In various embodiments, the secondary storage device 406 includes various types of computer storage media. For example, the secondary storage device 406 can include one or more magnetic disks, magnetic tape drives, optical discs, solid state memory devices, and/or other types of computer storage media.

The network interface card 408 enables the computing device 400 to send data to and receive data from a communication network. In different embodiments, the network interface card 408 is implemented in different ways. For example, the network interface card 408 can be implemented as an Ethernet interface, a token-ring network interface, a fiber optic network interface, a wireless network interface (e.g., WiFi, WiMax, etc.), or another type of network interface.

The video interface 410 enables the computing device 400 to output video information to the display unit 412. The display unit 412 can be various types of devices for displaying video information, such as a cathode-ray tube display, an LCD display panel, a plasma screen display panel, a touch-sensitive display panel, an LED screen, or a projector. The video interface 410 can communicate with the display unit 412 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 414 enables the computing device 400 to communicate with external devices. For example, the external component interface 414 can be a USB interface, a FireWire interface, a serial port interface, a parallel port interface, a PS/2 interface, and/or another type of interface that enables the computing device 400 to communicate with external devices. In various embodiments, the external component interface 414 enables the computing device 400 to communicate with various external components, such as external storage devices, input devices, speakers, modems, media player docks, other computing devices, scanners, digital cameras, and fingerprint readers.

The communications medium 416 facilitates communication among the hardware components of the computing device 400. In the example of FIG. 4, the communications medium 416 facilitates communication among the memory 402, the processing system 404, the secondary storage device 406, the network interface card 408, the video interface 410, and the external component interface 414. The communications medium 416 can be implemented in various ways. For example, the communications medium 416 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 402 stores various types of data and/or software instructions. For instance, in the example of FIG. 4, the memory 402 stores a Basic Input/Output System (BIOS) 418 and an operating system 420. The BIOS 418 includes a set of computer-executable instructions that, when executed by the processing system 404, cause the computing device 400 to boot up. The operating system 420 includes a set of computer-executable instructions that, when executed by the processing system 404, cause the computing device 400 to provide an operating system that coordinates the activities and sharing of resources of the computing device 400. Furthermore, the memory 402 stores application software 422. The application software 422 includes computer-executable instructions, that when executed by the processing system 404, cause the computing device 400 to provide one or more applications. The memory 402 also stores program data 424. The program data 424 is data used by programs that execute on the computing device 400.

Although particular features are discussed herein as included within an electronic computing device 400, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The above specification, examples and data provide a complete description of the manufacture and use of the composition of the invention. Since many embodiments of the invention can be made without departing from the spirit and scope of the invention, the invention resides in the claims hereinafter appended.

1. A method of creating recipient-customizable promotional products, the method comprising:
receiving design details from a customer associated with layout of one or more graphical elements on a promotional product;
building a design of a customized promotional product using the design details;
generating a personalization symbol to be applied to each promotional product, the personalization symbol linked in a database to content;
making a plurality of the customized promotional products, each of the customized promotional products created according to the design details and including a personalization symbol, thereby creating personalized customized promotional products; and
distributing the personalized customized promotional products to the customer.

2. The method of claim 1, wherein the content comprises an invitation of admission to an event.

3. The method of claim 1, wherein the content comprises a promotional offer for sale of an item at an event.

4. The method of claim 1, wherein the personalization symbol comprises a QR code.

5. The method of claim 1, wherein making the plurality of customized promotional products comprises printing one or more of the graphical elements and the personalization symbol on each of the promotional products.

6. The method of claim 1, wherein each of the plurality of personalized customized promotional products has a different personalization symbol disposed thereon.

7. The method of claim 6, wherein each of the different personalization symbols is associated in a database with a different person to whom the promotional product is distributed.

8. The method of claim 1, further comprising:
receiving from the customer an identifier associated with the personalization symbol;
accessing the database to determine a promotion associated with the identifier;
providing information to the customer indicative of the promotion.

9. The method of claim 8, wherein the information represents an access right to an event.

10. The method of claim 8, wherein the information represents a discount on sale of a good or service.

11. A system comprising:
an on-demand product customizer including:
a programmable circuit;
a memory operatively connected to the programmable circuit and configured to store instructions executable thereon, the instructions, when executed on the programmable circuit, cause the on-demand product customizer to:
receive design details from a customer associated with layout of one or more graphical elements on a promotional product;
build a design of a customized promotional product using the design details;
generate a personalization symbol to be applied to each promotional product, the personalization symbol linked in a database to content; and
a customized product printing system operatively connected to the on-demand product customizer, the customized product printing system configured to:
make a plurality of the customized promotional products, each of the customized promotional products created according to the design details and including a personalization symbol, thereby creating personalized customized promotional products.

12. The system of claim 11, further comprising a database storing product and customer data.

13. The system of claim 12, wherein the product and customer data includes inventory data relating to non-customized promotional products.

14. The system of claim 11, wherein the plurality of the customized promotional products includes one or more types of products selected from a group of product types consisting of:
shirts;
glasses;
mugs;
key fobs;
cards; and
tickets.

15. A method of creating recipient-customizable promotional products, the method comprising:
providing design details to an on-demand product customizer, the design details associated with layout of one or more graphical elements on a promotional product;
ordering a designed customized promotional product using the design details, the design details including a personalization symbol linked in a database to one or more offers to a user;
receiving a plurality of the designed customized promotional products, each of the customized promotional products created according to the design details and including a personalization symbol, thereby creating personalized customized promotional products; and
distributing the personalized customized promotional products to a plurality of individuals;
scanning the personalization symbol on one of the personalized customized promotional products of one of the plurality of individuals;
transmitting information identifying the personalization symbol to a remote system; and
receiving information indicative of a promotion associated with the personalization symbol to be provided to the individual.

16. The method of claim 15, wherein the remote system comprises the on-demand product customizer.

17. The method of claim 15, wherein the information represents an access right to an event.

18. The method of claim 15, wherein the information represents a discount on sale of a good or service.

19. The method of claim 15, wherein each of the personalization symbols is associated with a different person to whom the promotional product is distributed in a database associated with the on-demand product customizer.
